(19) United States
(12) Patent Application Publication
(10) Pub. No.: US 2009/0269458 A1
(43) Pub. Date: Oct. 29, 2009

(54) POWDER BEING RICH IN MILK-ORIGIN COMPLEX LIPIDS

(76) Inventors: Susumu Miura, Kawagoe (JP); Kenji Kojima, Kawagoe (JP); Taku Nakano, Kawagoe (JP); Ken Kato, Kawagoe (JP); Akira Tomizawa, Kawagoe (JP); Toshimitsu Yoshioka, Kawagoe (JP)

Correspondence Address: KNOBBE MARTENS OLSON & BEAR LLP, 2040 MAIN STREET, FOURTEENTH FLOOR, IRVINE, CA, 92614, US

(21) Appl. No.: 12/088,224

(22) PCT Filed: Sep. 27, 2006
(86) PCT No.: PCT/JP2006/319141

§ 371 Date: Jun. 3, 2008

(30) Foreign Application Priority Data
Sep. 30, 2005 (JP) 2005-286602

(51) Int. Cl. A23C 9/18; A23C 9/142; A23C 1/14

(52) U.S. Cl. 426/588; 426/422

(57) ABSTRACT

Manufacture a powder with high milk-derived complex lipid content that contains milk-derived phospholipids and milk-derived ganglioside at high concentrations, which contains protein by 15 to 35 percent by dry weight and fat by 45 to 60 percent by dry weight, wherein the content of milk-derived complex lipids is 20 percent by dry weight or more, and which can be utilized as a material for functional food, mother's milk substitute or drug, by means of adjusting the pH value of a butter serum or butter serum powder reconstituted liquid to a range of 4.0 to 5.0, adding calcium chloride to promote coagulation of protein, removing the produced sediments, filtering the supernatant by means of ultrafiltration or microfiltration, and then drying the obtained concentrate.

### TECHNICAL FIELD

The present invention relates to a powder with high milk-derived complex lipid content. More specifically, the present invention relates to a powder with high milk-derived complex lipid content that contains milk-derived phospholipids and milk-derived ganglioside at high concentrations.

A powder with high milk-derived complex lipid content obtained in accordance with the present invention can be utilized widely as a material for functional food, mother's milk substitute or drug.

### RELATED ART

Soybean lecithin and egg yolk lecithin, which are crude phospholipid products derived from natural substances, are utilized widely as emulsifiers and other additives in the production of food. In recent years, phosphatidylserine, phosphatidylcholine, sphingomyelin and other milk-derived phospholipids are drawing the attention after reports of various physiological functions exhibited by these phospholipids.

It has been reported that phosphatidylserine and phosphatidylcholine are involved deeply in the development and maintenance of neurological function and motor function, and that sphingomyelin helps the intestinal tract to mature in small children. Sphingomyelin is a substance that accounts for approx. 30% of all phospholipids in milk and has a structure comprising phosphocholine bonding with a ceramide skeleton constituted by sphingosine and fatty acids.

Sphingomyelin exists in brain and nerve tissues in large quantities, but its content is minimal in soybean phospholipids and egg yolk phospholipids.

In the meantime, milk-derived ganglioside has a structure comprising sialic acid bonding, via sugar, with a ceramide skeleton constituted by sphingosine and fatty acids. It is present mainly in the forms of GD3 and GM3 and found widely in cow brain and milk. In recent years, biochemical research of milk-derived ganglioside is making progress and revealing such physiological functions of milk-derived ganglioside as cell differentiation, facilitation of neurological function, and protection of virus infection.

On the other hand, butter serum is a water-phase component discharged when high fat cream with a fat content of 60% or more, obtained by separating raw milk using a separator and again separating the obtained cream with a fat content of 40 to 50% using a separator, is heated or sheared to cause phase inversion, or butter serum also refers to a water-phase component that separates from butter when butter is melted under heat, and thus butter serum is different from butter milk which is a water-phase component and byproduct generated from the butter manufacturing process. Butter serum is known to contain a lot of fat globule membrane components found in milk, and it is also a rich source of complex lipids such as phospholipids and glycolipids that constitute fat globule membrane components. The solid content of milk-derived complex lipids in butter serum is known to be 5 percent by weight or more, which is 10 times or more of the solid content of milk-derived complex lipids in butter milk of just 0.5 percent by weight. In addition, among various methods for preparing a material containing milk-derived complex lipids, a method to adjust the pH value of a butter milk or butter milk powder reconstituted liquid to the acid range, cause isoelectric precipitation to remove the produced protein sediments, and then filter the supernatant by means of microfiltration and dry the obtained concentrate to obtain the a powder with high content of phospholipids, is known (Patent Literature 1).

There is also a method to extract a butter milk, skim milk powder or milk product using a solvent prepared by mixing chloroform, methanol and water at a ratio of 4 to 8 to 3, acetone, or other organic solvent (Patent Literature 2).

However, while it does not use any organic solvent, the method described in Patent Literature 1 uses butter milk or butter milk reconstituted liquid as the starting material and therefore it can only condense the phospholipids content to 15 percent by weight, which is not ideal in terms of cost effectiveness. This is because when the manufacturing method described in Patent Literature 1 is used, the ratio of complex lipids to all fat contained in the material becomes the same as the ratio of complex lipids to all fat contained in the finally obtained powder. Also, it has been suggested that this method, in which adjusting the pH value to the acid range is the only process used before removing casein protein, allows casein protein to remain in the supernatant and this remaining casein protein may cause allergic reaction to milk in the body. Furthermore, the method described in Patent Literature 2, while capable of condensing phospholipids to a high purity level of 90% or more, uses chloroform, diethyl ether, methanol and other organic solvents that are not approved for use in the preparation of food materials. Accordingly, utilizing this method in food applications is difficult and even if the method can be utilized in these applications, the cost becomes high.

On the other hand, known methods for manufacturing ganglioside include a method to obtain fat globule membranes from butter milk (Patent Literature 3) and a method to use an ion exchange resin (Patent Literature 4).

However, it is very difficult to manufacture a composition with high ganglioside content on an industrial scale using the method described in Patent Literature 3. Also, the method described in Patent Literature 4 uses an ion exchange resin and thus is not suitable for mass production applications in industrial settings.

To solve the aforementioned problems presented by prior arts, the inventors had earlier proposed a simple method to manufacture a material with high ganglioside content by using ethanol (Patent Literature 5).

However, while it is capable of manufacturing a material with high ganglioside content in a large quantity, this method uses ethanol and therefore requires a number of complex facilities and processes including explosion-proof facilities. In addition, removing ethanol smell completely from the final product is extremely difficult, which makes it hard to utilize this method in the production of food materials.

Patent Literature 1: Japanese Patent No. 3103218

Patent Literature 2: Japanese Patent Laid-open No. Hei 3-47192

Patent Literature 3: Japanese Patent Laid-open No. Sho 60-72819

Patent Literature 4: Japanese Patent Laid-open No. Hei 2-207090

Patent Literature 5: Japanese Patent Laid-open No. Hei 9-291094

### SUMMARY OF THE INVENTION

### Problems to Be Solved by the Invention

Manufacture of a material with high complex lipid content that contains milk-derived phospholipids and ganglioside at high concentrations has not been possible using any of the prior art methods mentioned above.

Accordingly, it is an object of the present invention to solve the problems presented by the aforementioned prior arts by providing a powder with high milk-derived complex lipid content that contains both phospholipids and ganglioside at high concentrations and can be utilized as a material for functional food, mother's milk substitute or drug. To be specific, it is possible to obtain a powder with high milk-derived complex lipid content that contains protein by 15 to 35 percent by dry weight and fat by 45 to 60 percent by dry weight, wherein the content of milk-derived complex lipids is 20 percent by dry weight or more, in accordance with the present invention.

### Means for Solving the Problems

The inventors carried out diligent studies to improve the yield of complex lipids such as phospholipids and also manufacture a material that contains such complex lipids at high levels, with the purpose of effectively utilizing milk-derived complex lipids. As a result, the inventors were able to successfully prepare a desired powder by using butter serum or butter serum powder reconstituted liquid as the material and using the process whereby calcium chloride is added to the material, after which casein, being the key protein in the material, is coagulated and precipitated at its isoelectric point, and then the obtained supernatant is filtered by means of ultrafiltration or microfiltration to remove most of residual substances such as other proteins, milk sugar and minerals, and finally the complex lipids are condensed and dried. The obtained powder contained protein by 15 to 35 percent by dry weight, and fat by 45 to 60 percent by dry weight, wherein the content of milk-derived complex lipids was 20 percent by dry weight or more.

With a powder with high milk-derived complex lipid content conforming to the present invention, the protein content can be controlled within a range of 15 to 35 percent by weight, while the fat content can be controlled within a range of 45 to 60 percent by weight, by controlling the conditions of ultrafiltration or microfiltration processing or controlling the conditions under which casein is removed. On the other hand, however, the ratio of complex lipids contained in fat is affected by the fat content in the material butter serum or butter serum powder reconstituted liquid, and also by the composition of this fat content, and therefore it is desirable to understand, prior to the manufacturing process, the fat content and fat composition of the material butter serum and butter serum powder reconstituted liquid.

For your information, in a powder with high milk-derived complex lipid content conforming to the present invention, the sphingomyelin content becomes 4 percent by weight, and the content of glycolipids such as ganglioside becomes 0.3 percent by weight, when the content of phospholipids is 20 percent by weight or more.

### EFFECTS OF THE INVENTION

The present invention provides a powder with high milk-derived complex lipid content that contains protein by 15 to 35 percent by dry weight, fat by 45 to 60 percent by dry weight, and milk-derived complex lipids by 20 percent by dry weight or more, by adjusting the pH value of a butter serum or butter serum powder reconstituted liquid to a range of 4.0 to 5.0, causing isoelectric precipitation in the most efficient manner to remove casein sediments, filtering the supernatant by means of ultrafiltration or microfiltration, and then drying the obtained concentrate; wherein, during the process of precipitating and removing casein at its isoelectric point, calcium chloride is added by 0.01 to 0.1 percent by weight relative to the total quantity to promote precipitation so that casein sediments can be removed efficiently even when the mixture is kept stationary.

Also, the obtained powder with high milk-derived complex lipid content can be used as a material for functional food, mother's milk substitute or drug.

### BEST MODE FOR CARRYING OUT THE INVENTION

The method for manufacturing a powder with high milk-derived complex lipid content conforming to the present invention is explained below.

The content of complex lipids (phospholipids and glycolipids) in butter serum powder is 5 percent by weight, which is 10 times higher than the content in butter milk powder of 0.5 percent by weight. Also, this butter serum is a byproduct of the AMF (Anhydrous Milk Fat; butter oil) manufacturing process and therefore can be obtained inexpensively, which makes it an ideal material for use under the present invention. Accordingly, butter serum or butter serum powder is used as the material and if butter serum powder is used, it is dissolved in water to achieve a concentration of approx. 10 percent by weight to prepare a reconstituted liquid, after which casein, being the key protein of the material, is coagulated and precipitated at its isoelectric point (pH 4.0 to 5.0) to separate and remove the sediments. At this time, calcium chloride is added by 0.01 to 0.05 percent by weight relative to the total quantity to further promote the coagulation of casein and thereby allow for efficient separation of casein. Although the method for separating the sediments is not specifically limited, it is desirable to use centrifugal separation, filter press or decantation, among others. Centrifugal separation can be performed favorably under the condition where the centrifugal acceleration is maintained at 400 G or above. Addition of calcium chloride promotes coagulation and precipitation of casein, which makes it possible to implement a continuous manufacturing process using centrifugal separation. When the protein composition in the supernatant obtained by this operation was checked by means of SDS-PAGE electrophoresis, it was found that casein had been completely removed from the supernatant.

Thus obtained supernatant contains a fat component that contains whey protein, milk sugar, minerals, and complex lipids of interest here. Under the present invention, membrane separation technology is applied to further condense complex lipids. The non-fat component in the supernatant is known to be whey protein with a molecular weight of approx. 18,000, while it is also known that fat exists in an emulsion form in the supernatant and, in particular, complex lipids are dispersed as molecular aggregates. For this reason, it is desirable to condense the complex lipids in the supernatant by using ultrafiltration membranes (with a fractional molecular weight of 5 kDa or more) or microfiltration membranes (with a fractional grain size of 0.1 to 1.4 μm). Although the solid content of the obtained concentrate includes a high content of fat at 45 to 60 percent by weight, this solid content can be pulverized easily using a spray-drying machine commonly utilized in the food industry to obtain a powder containing complex lipids by 20 percent by weight or more.

For your information, while casein can be precipitated and removed through addition of calcium chloride after adjusting the pH value of the material to the acid range, the supernatant still contains residual whey protein, milk sugar, minerals, etc., and thus it is preferable to use ultrafiltration membranes with a fractional molecular weight of 5 kDa or more so that whey protein, milk sugar, minerals, etc., in the supernatant can be removed as much as possible while the fat fraction can be retained in the concentrate. For the same reason, microfiltration membranes with a fractional grain size of 0.1 to 1.4 μm are also preferable.

Under the present invention, any drying method can be used as deemed appropriate, such as freeze drying, vacuum drying, or drying by hot air, in addition to spray drying. Thus obtained powder conforming to the present invention has low protein and sugar contents, while the fat content is 45 to 60 percent by dry weight and the content of complex lipids among fat is 20 percent by dry weight or more. Next, the present invention is explained in concrete terms using examples.

### EXAMPLE 1

A butter serum powder reconstituted liquid with a solid content of 20 percent by weight was prepared by adding 20 kg of material butter serum powder (SM2, Corman S.A.) and 80 kg of water heated to 50° C. and then agitating the mixture to dissolve the material. This butter serum powder reconstituted liquid was then mixed with 10% hydrochloric acid to adjust its pH value to 4.4. At the same time, calcium chloride was also mixed by 0.02 percent by weight relative to the total quantity, after which the mixture was kept for 30 minutes at 50° C. to coagulate casein. The produced casein sediments were completely removed using a quark separator to obtain a supernatant. This supernatant was filtered through microfiltration membranes with a fractional grain size of 0.1 μm and the concentrate was collected and then freeze-dried to obtain a powder with high milk-derived complex lipid content conforming to the present invention. When the fat content in the obtained powder was measured using the Roese-Gottlieb method, the powder contained fat by 50 percent by weight.

When the phospholipids content and ganglioside content in the fat were measured, the fat contained phospholipids by 27 percent by weight, and ganglioside GD3 by 1.0 percent by weight.

### COMPARATIVE EXAMPLE 1

A butter milk powder reconstituted liquid with a solid content of 20 percent by weight was prepared by adding 20 kg of material butter milk powder (Snow Brand Milk Products Co., Ltd.) and 80 kg of water heated to 50° C. and then agitating the mixture to dissolve the material. This butter milk powder reconstituted liquid was then mixed with 10% hydrochloric acid to adjust its pH value to 4.4. At the same time, calcium chloride was also mixed by 0.02 percent by weight relative to the total quantity, after which the mixture was kept for 30 minutes at 50° C. to coagulate casein. The produced casein sediments were completely removed using a quark separator to obtain a supernatant.

This supernatant was filtered through microfiltration membranes with a fractional grain size of 0.1 μm and the concentrate was collected and then freeze-dried to obtain a powder with high milk-derived complex lipid content conforming to the present invention.

When the fat content in the obtained powder was measured using the Roese-Gottlieb method, the powder contained fat by 40 percent by weight.

When the phospholipids content and ganglioside content in the fat were measured, however, the fat contained phospholipids by just 13 percent by weight, and ganglioside GD3 by just 0.3 percent by weight.

### EXAMPLE 2

100 kg of material butter serum (Uelzena eG) (solid content: 20 percent by weight) was mixed with 3N hydrochloric acid to adjust its pH value to 4.4. At the same time, calcium chloride was also mixed by 0.03 percent by weight relative to the total quantity, after which the mixture was kept for 30 minutes at 50° C. to coagulate casein. The produced casein sediments were completely removed using a quark separator to obtain a supernatant. This supernatant was filtered through microfiltration membranes with a fractional grain size of 0.1 μm and the concentrate was collected and then spray-dried to obtain a powder with high milk-derived complex lipid content conforming to the present invention.

When the fat content in the obtained powder was measured using the Roese-Gottlieb method, the powder contained fat by 50 percent by weight.

When the phospholipids content and ganglioside content in the fat were measured, the fat contained phospholipids by 30 percent by weight, and ganglioside GD3 by 1.0 percent by weight.

### COMPARATIVE EXAMPLE 2

100 kg of material butter serum (Uelzena eG) (solid content: 20 percent by weight) was mixed with 3N hydrochloric acid to adjust its pH value to 4.4. Next, the mixture was kept for 30 minutes at 50° C. to coagulate casein. An attempt was made to separate the coagulated casein using a quark separator, but casein had not coagulated fully and therefore some casein remained in the supernatant. This supernatant was filtered through microfiltration membranes with a fractional grain size of 0.1 μm and the concentrate was collected and then spray-dried to obtain a powder with high milk-derived complex lipid content conforming to the present invention.

When the fat content in the obtained powder was measured using the Roese-Gottlieb method, the powder contained fat by just 40 percent by weight. When the phospholipids content and ganglioside content in the fat were measured, the fat contained phospholipids by just 15 percent by weight, and ganglioside GD3 by just 0.5 percent by weight.

These figures were likely resulted from an incomplete coagulation of casein due to absence of calcium chloride, which probably allowed casein to eventually remain in the concentrate after the mixture was filtered through the membranes.

### EXAMPLE 3

A butter serum powder reconstituted liquid with a solid content of 20 percent by weight was prepared by adding 20 kg of material butter serum powder (SM2, Corman S.A.) and 80 kg of water heated to 50° C. and then agitating the mixture to dissolve the material. This butter serum powder reconstituted liquid was then mixed with 10% hydrochloric acid to adjust its pH value to 4.4. At the same time, calcium chloride was also mixed by 0.05 percent by weight relative to the total quantity, after which the mixture was kept for 30 minutes at 50° C. to coagulate casein. The produced casein sediments were completely removed using a filter press to obtain a supernatant. This supernatant was filtered through microfiltration membranes with a fractional molecular size of 0.1 μm and the concentrate was collected and then spray-dried to obtain a powder with high milk-derived complex lipid content conforming to the present invention. When the fat content in the obtained powder was measured using the Roese-Gottlieb method, the powder contained fat by 55 percent by weight. When the phospholipids content and ganglioside content in the fat were measured, the fat contained phospholipids by 27 percent by weight, and ganglioside GD3 by 1.0 percent by weight.

### COMPARATIVE EXAMPLE 3

A butter serum powder reconstituted liquid with a solid content of 20 percent by weight was prepared by adding 20 kg of material butter serum powder (SM2, Corman S.A.) and 80 kg of water heated to 50° C. and then agitating the mixture to dissolve the material. This butter serum powder reconstituted liquid was then mixed with 10% hydrochloric acid to adjust its pH value to 4.4. At the same time, calcium chloride was also mixed by 0.05 percent by weight relative to the total quantity, after which the mixture was kept for 30 minutes at 50° C. to coagulate casein. The produced casein sediments were completely removed using a filter press to obtain a supernatant. This supernatant was filtered through microfiltration membranes with a fractional molecular size of 2.0 μm and the concentrate was collected and then spray-dried to obtain a powder with high milk-derived complex lipid content conforming to the present invention.

When the fat content in the obtained powder was measured using the Roese-Gottlieb method, the powder contained fat by just 35 percent by weight.

When the phospholipids content and ganglioside content in the fat were measured, the fat contained phospholipids by just 15 percent by weight, and ganglioside GD3 by just 0.3 percent by weight.

These figures were likely resulted from the large membrane hole size of 2.0 μm in the microfiltration membranes used in the filtration processing, which probably caused the fat fraction to flow into the permeate.

### EXAMPLE 4

100 kg of material butter serum (Uelzena eG) (solid content: 20 percent by weight) was mixed with 15% hydrochloric acid to adjust its pH value to 4.5. At the same time, calcium chloride was also mixed by 0.03 percent by weight relative to the total quantity, after which the mixture was kept for 30 minutes at 60° C. to coagulate casein. The produced casein sediments were completely removed using a nozzle separator to obtain a supernatant. This supernatant was filtered through ultrafiltration membranes with a fractional molecular weight of 10 kDa and the concentrate was collected and then freeze-dried to obtain a powder with high milk-derived complex lipid content conforming to the present invention.

When the fat content in the obtained powder was measured using the Roese-Gottlieb method, the powder contained fat by 55 percent by weight.

When the phospholipids content and ganglioside content in the fat were measured, the fat contained phospholipids by 30 percent by weight, and ganglioside GD3 by 0.8 percent by weight.

1. A powder with high milk-derived complex lipid content characterized by containing protein by 15 to 35 percent by dry weight and fat by 45 to 60 percent by dry weight, wherein the content of milk-derived complex lipids is 20 percent by dry weight or more; said powder being obtained by adjusting a pH value of a butter serum or a reconstituted liquid of butter serum powder to 4.0 to 5.0, adding calcium chloride and removing a produced sediments, filtering a supernatant by ultrafiltration or microfiltration, and then drying the obtained concentrate.

2. The powder with high milk-derived complex lipid content according to claim 1, characterized in that the milk-derived complex lipids comprise 20 percent by dry weight or more of phospholipids and 0.3 percent by dry weight or more of glycolipids.

3. The powder with high milk-derived complex lipid content according to claim 1, characterized in that calcium chloride is added by 0.01 to 0.05 percent by weight relative to the total quantity.

4. The powder with high milk-derived complex lipid content according to claim 1, characterized in that ultrafiltration is performed at a fractional molecular weight of 5 kDa or more.

5. The powder with high milk-derived complex lipid content according to claim 1, characterized in that microfiltration is performed at a fractional grain size of 0.1 to 1.4 μm.

6. The powder with high milk-derived complex lipid content according to claim 1, characterized in that said powder is used as a material for functional food, mother's milk substitute or drug.

7. A method for producing a powder containing at least 20% by dry weight of milk-origin complex lipids, comprising:
providing a raw material constituted by a butter serum or a reconstituted liquid of butter serum powder;
adjusting a pH value of the raw material to 4.0 to 5.0 and adding calcium chloride to the raw material, thereby forming sediments of casein contained in the raw material;
obtaining a supernatant by separating the sediments of casein;
filtering the supernatant by ultrafiltration or microfiltration, thereby removing proteins other than casein, lactose, and minerals; and
drying the thus obtained filtrate to obtain a powder containing milk-origin complex lipids in an amount of 20% by weight or higher as a result of the foregoing steps.

8. The method according to claim 7, wherein the raw material consists of the butter serum or the reconstituted liquid of butter serum powder.

9. The method according to claim 7, wherein the calcium chloride is added in an amount of 0.01 to 0.05% by weight based on the raw material.

10. The method according to claim 7, wherein the supernatant is free of casein.

11. The method according to claim 7, wherein the resultant powder contains protein by 15 to 35 percent by dry weight and fat by 45 to 60 percent by dry weight.

12. The method according to claim 7, wherein the ultrafiltration is performed at a fractional molecular weight of 5 kDa or more.

13. The method according to claim 7, wherein the microfiltration is performed at a fractional grain size of 0.1 to 1.4 μm.
